(19) United States
(12) Patent Application Publication
(10) Pub. No.: US 2002/0004450 A1
(43) Pub. Date: Jan. 10, 2002

(54) Thermal shock resistant catalysts for synthesis gas production

(76) Inventors: Anne M. Gaffney, West Chester, PA (US); Robert A. Oswald, Milton, DE (US); Roger Song, Wilmington, DE (US)

Correspondence Address: Joanna Payne, CONOCO INC., 1000 South Pine 2635 RW, P O Box 1267, Ponca City, OK, 74602-1267, US

(21) Appl. No.: 09/765,945

(22) Filed: Jan. 19, 2001

Related U.S. Application Data
(60) Provisional application No. 60/177,432, filed on Jan. 21, 2000.

(51) Int. Cl. C01B 31/18; B01J 21/10; B01J 23/46

(52) U.S. Cl. 502/256; 502/257; 502/261; 502/259; 502/306; 502/315; 502/326; 502/327; 502/328; 502/337; 423/418.2; 423/651

(57) ABSTRACT

Syngas catalyst compositions supported on refractory ceramic textiles and fibrous ceramic composite catalysts are disclosed, together with their methods of making and use for catalyzing syngas production from methane by a net partial oxidation reaction. In certain preferred embodiments the active catalyst material is Rh, Ni, Cr, or combinations thereof. The ceramic textiles may be arranged in a variety of 3-D forms, such as Nextel™ or various woven or braided meshes and layers. The ceramic textile is easier to scale up to commercial reactor dimensions than the conventional foams and monoliths comprising ceramics and metals. Tolerance to thermal expansion and thermal heat integration are also improved by the new catalysts. A synthesis gas production process employs a new ceramic composite catalyst in a fixed reaction zone maintained at conversion-promoting conditions effective to produce an effluent stream comprising carbon monoxide and hydrogen in a molar ratio of about 2:1 H₂/CO.

### CROSS-REFERENCE TO RELATED APPLICATIONS

This application claims the benefit under 35 U.S.C. § 119(e) of U.S. Provisional Patent Application No. 60/177,432 filed Jan. 21, 2000.

### BACKGROUND OF THE INVENTION

1. Field of the Invention

The present invention generally relates to processes for converting light hydrocarbons (e.g., natural gas) to products containing carbon monoxide and hydrogen using supported metal catalysts. More particularly, the invention relates to ceramic oxide fiber supported catalysts and fibrous ceramic composite catalysts and their manner of making, and to processes employing such catalysts for the generation of synthesis gas.

2. Description of Related Art

Large quantities of methane, the main component of natural gas, are available in many areas of the world, and natural gas is predicted to outlast oil reserves by a significant margin. However, most natural gas is situated in areas that are geographically remote from population and industrial centers. The costs of compression, transportation, and storage make its use economically unattractive.

To improve the economics of natural gas use, much research has focused on methane as a starting material for the production of higher hydrocarbons and hydrocarbon liquids. The conversion of methane to hydrocarbons is typically carried out in two steps. In the first step, methane is reformed with water to produce carbon monoxide and hydrogen (i.e., synthesis gas or syngas). In a second step, the syngas is converted to hydrocarbons, for example, using the Fischer-Tropsch process to provide fuels that boil in the middle distillate range, such as kerosene and diesel fuel, and hydrocarbon waxes.

Current industrial use of methane as a chemical feedstock proceeds by the initial conversion of methane to carbon monoxide and hydrogen by either steam reforming, which is the most widespread process, or by dry reforming. Steam reforming currently is the major process used commercially for the conversion of methane to synthesis gas, proceeding according to Equation 1.

CH₄+H₂O⇄CO+3H₂ (1)

Although steam reforming has been practiced for over five decades, efforts to improve the energy efficiency and reduce the capital investment required for this technology continue.

The catalytic partial oxidation of hydrocarbons, e.g., natural gas or methane to syngas is also a process known in the art. While currently limited as an industrial process, partial oxidation has recently attracted much attention due to significant inherent advantages, such as the fact that significant heat is released during the process, in contrast to steam reforming processes.

In catalytic partial oxidation, natural gas is mixed with air, oxygen-enriched air, or oxygen, and introduced to a catalyst at elevated temperature and pressure. The partial oxidation of methane yields a syngas mixture with a H₂:CO ratio of 2:1, as shown in Equation 2.

CH₄+½O₂⇄CO+2H₂ (2)

This ratio is more useful than the H₂:CO ratio from steam reforming for the downstream conversion of the syngas to chemicals such as methanol and to fuels. The partial oxidation is also exothermic, while the steam reforming reaction is strongly endothermic. Furthermore, oxidation reactions are typically much faster than reforming reactions. This allows the use of much smaller reactors for catalytic partial oxidation processes. The syngas in turn may be converted to hydrocarbon products, for example, fuels boiling in the middle distillate range, such as kerosene and diesel fuel, and hydrocarbon waxes by processes such as the Fischer-Tropsch Synthesis.

The selectivities of catalytic partial oxidation to the desired products, carbon monoxide and hydrogen, are controlled by several factors, but one of the most important of these factors is the choice of catalyst composition. Difficulties have arisen in the prior art in making such a choice economical. Typically, catalyst compositions have included precious metals and/or rare earths. The large volumes of expensive catalysts needed by prior art catalytic partial oxidation processes have placed these processes generally outside the limits of economic justification.

For successful operation at commercial scale, the catalytic partial oxidation process must be able to achieve a high conversion of the methane feedstock at high gas hourly space velocities, and the selectivity of the process to the desired products of carbon monoxide and hydrogen must be high. Such high conversion and selectivity must be achieved without detrimental effects to the catalyst, such as the formation of carbon deposits (“coke”) on the catalyst, which severely reduces catalyst performance. Accordingly, substantial effort has been devoted in the art to the development of catalysts allowing commercial performance without coke formation.

A number of process regimes have been proposed in the art for the production of syngas via catalyzed partial oxidation reactions. One such process, described in U.S. Pat. No. 4,877,550 employs a syngas generation process using a fluidized reaction zone. Such a process however, requires downstream separation equipment to recover entrained supported-nickel catalyst particles.

To overcome the relatively high pressure drop, typically associated with gas flow through a fixed bed of catalyst particles, which can prevent operation at the required high gas space velocities, various active metal gauzes or wire meshes and various porous structures for supporting the active catalyst in the reaction zone have been proposed. For example, M. Fathi et al., Catal. Today, 42, 205-209 (1998) disclose Pt, Pt/Rh, Pt/Ir and Pd gauze catalysts for the catalytic partial oxidation of methane at contact times of 0.21 to 0.33 milliseconds. Pt, Pt/5% Rh and Pt/10% Rh gauzes were tested at 700 to 1100° C. The best results were obtained at 1100 C. using the Pt/10% Rh gauze catalyst. The CH₄ conversion was about 30%; the oxygen conversion was about 60%; the CO selectivity was about 95%; and the hydrogen selectivity was about 30%.

European Pat. App. No. 0640559A1 discloses a process for the partial oxidation of natural gas which is carried out by means of a catalyst constituted by one or more compounds of metals from the Platinum Group, which is given the shape of wire meshes, or is deposited on a carrier made from inorganic compounds, in such a way that the level of metal or metals from Platinum Group (i.e., Rh, Ru and Ir), as percent by weight, comprise within the range of from 0.1 to 20% of the total weight of catalyst and carrier. The partial oxidation is carried out at temperatures in the range of from 300 to 950° C., at pressures in the range of from 0.5 to 50 atmospheres, and at space velocities comprised in the range of from 20,000 to 1,500,000 h⁻¹.

European Pat. App. No. 0576096A2 discloses a process for the catalytic partial oxidation of a hydrocarbon feedstock, which process comprises contacting a feed comprising the hydrocarbon feedstock, an oxygen-containing gas and, optionally, steam at an oxygen-to-carbon molecular ratio in the range of from 0.45 to 0.75, at elevated pressure with a catalyst in a reaction zone under adiabatic conditions. The catalyst comprises a metal selected from Group VIII of the Periodic Table and supported on a carrier and is retained within the reaction zone in a fixed arrangement having a high tortuosity. The process is characterized in that the catalyst comprises a metal selected from ruthenium, rhodium, palladium, osmium, iridium and platinum, and the fixed arrangement of the catalyst is in a form selected from a fixed bed of a particulate catalyst, a metal gauze and a ceramic foam.

V. R. Choudhary et al. (“Oxidative Conversion of Methane to Syngas over Nickel Supported on Low Surface Area Catalyst Porous Carriers Precoated with Alkaline and Rare Earth Oxides,” J. Catal., Vol. 172, pages 281-293, 1997) disclose the partial oxidation of methane to syngas at contact times of 4.8 ms (at STP) over supported nickel catalysts at 700 and 800° C. The catalysts were prepared by depositing NiO-MgO on different commercial low surface area porous catalyst carriers consisting of refractory compounds such as SiO₂, Al₂O₃, SiC, ZrO₂ and HfO₂. The catalysts were also prepared by depositing NiO on the catalyst carriers with different alkaline and rare earth oxides such as MgO, CaO, SrO, BaO, Sm₂O₃ and Yb₂O₃.

U.S. Pat. No. 5,149,464 discloses a method for selectively converting methane to syngas at 650° C. to 950° C. by contacting the methane/oxygen mixture with a solid catalyst, which is either:

a catalyst of the formula MₓM′_{y}O_{z} where:

M is at least one element selected from Mg, B, Al, Ln, Ga, Si, Ti, Zr, Hf and Ln where Ln is at least one member of lanthanum and the lanthanide series of elements;

M′ is a d-block transition metal, and

each of the ratios x/z and y/z and (x+y)/z is independently from 0.1 to 8; or

an oxide of a d-block transition metal; or

a d-block transition metal on a refractory support; or

a catalyst formed by heating a) or b) under the conditions of the reaction or under non-oxidizing conditions.

The d-block transition metals are stated to be selected from those having atomic number 21 to 29, 40 to 47 and 72 to 79, the metals scandium, titanium, vanadium, chromium, manganese, iron, cobalt, nickel, copper, zirconium, niobium, molybdenum, technetium, ruthenium, rhodium, palladium, silver, hafnium, tantalum, tungsten, rhenium, osmium, iridium, platinum and gold. Preferably M′ is selected from Fe, Os, Co, Rh, Ir, Pd, Pt and particularly Ni and Ru. The exemplary conversions, selectivities, and gas hourly space velocities are relatively low however, while reaction temperatures are relatively high, and the effects of coke formation are not addressed.

EPO 303 438 describes a monolithic catalyst (e.g., alumina on cordierite, with a Pt or Pd coating) with or without metal addition to the surface of the monolith for the partial oxidation of methane at space velocities of 20,000-500,000 hr⁻¹. Other suggested metal coatings of the monolith are Rh, Ir, Os, Ru, Ni, Cr, Co, Ce, La and mixtures thereof, in addition to metals of the groups IA, IIA, III, IV, VB, VIB and VIIB. Steam is required in the feed mixture to suppress coke formation on the catalyst. The partial oxidation of methane with the disclosed catalyst results in the production of significant quantities of carbon dioxide, steam, and C₂₊ hydrocarbons.

U.S. Pat. No. 5,510,056 discloses a monolithic support such as a ceramic foam or fixed catalyst bed having a specified tortuosity and number of interstitial pores that is said to allow operation at high gas space velocity. Catalysts used in that process include ruthenium, rhodium, palladium, osmium, iridium, and platinum. Data are presented for a ceramic foam supported rhodium catalyst at a rhodium loading of from 0.5-5.0 wt %.

U.S. Pat. No. 5,648,582 discloses another process for the catalytic partial oxidation of a feed gas mixture consisting of essentially methane. The methane-containing gas feed mixture and an oxygen-containing gas are passed over a supported metal catalyst at space velocities of 800,000 hr−1 to 12,000,000 hr−1. The catalyst is rhodium, nickel or platinum on a ceramic monolith support.

One drawback of conventional ceramic supported catalysts, however, is their poor thermal shock resistance and susceptibility to failure when hot spots form within the catalyst during use. The localized presence of highly exothermic reactions during the oxidative conversion of methane (due to, e.g., combustion, gas channeling or uneven distribution of catalyst) can generate hot spots within the catalyst. When combustive reactions are present, the excess methane and the full oxidation products can react endothermically to generate hydrogen and/or CO. Under such coexisting exothermic and endothermic conditions, thermal shock can drastically shorten the lifetime of a refractory ceramic-supported catalyst. Moreover, thermal runaway conditions may also take place if the catalyst irreversibly degrades into products that selectively accelerate exothermic reactions or which reduce the incidence of endothermic reactions. Likewise, conventional metal meshes or gauzes employed as active catalysts or catalyst supports tend to melt when highly exothermic hot spots occur in the catalyst bed, which also leads to early catalyst failure on-stream.

None of the existing catalytic partial oxidation processes are capable of providing sufficiently high conversion of reactant gas and high selectivity of CO and H₂ reaction products without employing a quantity of rare and costly catalysts, or without experiencing excessive coking of the catalyst, or without experiencing premature catalyst failure due to lack of heat resistance and mechanical instability of the catalyst or its support structure. Accordingly, there is a continuing need for better, more economical processes and catalysts for the catalytic partial oxidation of hydrocarbons, particularly methane, or methane containing feeds, in which the catalyst is mechanically stable and retains a high level of activity and selectivity to CO and H₂ products under conditions of high gas space velocity, elevated pressure and high temperature, without experiencing excessive coking.

### SUMMARY OF THE INVENTION

The catalysts and processes of the present invention overcome some of the deficiencies of existing catalysts and processes for converting light hydrocarbon feedstocks to synthesis gas. Some advantages of the new ceramic oxide fabric catalyst supports and fibrous ceramic composite catalysts are that they are more easily formed than many conventional catalyst articles and are readily scaled to fit the dimensions of any reactor. Especially significant advantages of the new catalysts are that they resist thermal shock better than conventional ceramic catalyst monoliths or supports, and avoid hot-spot induced meltdown problems that are typical of metal mesh or gauze catalysts. The new ceramic oxide fabric catalyst supports and fibrous ceramic composite catalysts may be formed into any of a variety of three-dimensional configurations, and may employ various fiber diameters, woven or braided mesh designs and layers. For instance, a catalyst bed for a reduced scale syngas production system contain a stack or layers of fabric disks formed from the ceramic oxide fabric supported catalysts or the fibrous ceramic composite catalysts.

In accordance with certain embodiments of the invention, a catalyst for catalytically converting a C₁-C₅ hydrocarbon to a product comprising CO and H₂ is provided. This catalyst, or catalyst article, which may be a fabric or textile, comprises a refractory fibrous structure containing a plurality of ceramic oxide fibers. The catalyst also has at least one active catalyst material supported by the fibrous structure. The active catalyst material has catalytic activity for partially oxidizing methane to CO and H₂ at conversion promoting conditions, and is preferably Rh, Ni or Cr, or a combination of any of those. The activity of the catalyst article is comparable to that of conventional, more costly, Group VIII containing syngas catalysts. The fibers of the support or the composite structure are arranged in the structure in such a way that they are able to move relative to one another within the structure, whereby thermomechanical stress is relieved when the structure is exposed to temperatures greater than 1000° C. In some embodiments, the catalyst includes a refractory oxide coating on the fibrous structure, lying between the fibrous structure and the active catalyst material.

In preferred embodiments, the ceramic oxide fibers of the catalyst article comprise a refractory metal oxide that is alumina, silica, boria, cordierite, magnesia, zirconia, or a combination of any of those oxides. Certain of these embodiments contain ceramic oxide fibers comprising Al₂O₃, B₂O₃, SiO₂, or a combination of any of those.

In certain embodiments, the catalyst is a piece of fabric in which a group of ceramic oxide fibers are woven together 2-dimensionally. Some embodiments have fibers woven together 3-dimensionally. A stacked catalyst structure may be formed from two or more such fibrous pieces. Preferably a group of 10-12 micron diameter fibers form the fabric. In some embodiments the fibers are polycrystalline metal oxide fibers, which may be transparent and nonporous.

In certain alternative embodiments, a ceramic composite catalyst for catalytically converting a C₁-C₅ hydrocarbon to a product comprising CO and H₂ is provided which has a refractory fibrous structure containing a plurality of fibers. These fibers contain a mixture of at least one active catalyst material and at least one ceramic oxide, the active catalyst material being one with catalytic activity for partially oxidizing methane to CO and H₂ at conversion promoting conditions.

Also provided in accordance with the present invention is a method of making a thermomechanical stress resistant catalyst for the production of synthesis gas comprising. In some embodiments, the method includes forming at least one fabric piece comprising a plurality of ceramic oxide fibers containing at least one refractory oxide such as alumina, silica, boria, cordierite, magnesia and zirconia, or mixtures thereof. The piece or pieces may then be coated with MgO. The method may include drying each such MgO coated piece, especially if there is a solvent to be evaporated. The piece or pieces (or the MgO coated piece or pieces, after calcination) are loaded with a catalyst precursor, such as a salt of a metal like rhodium, nickel, chromium, or any combination of those. Loading of the catalyst precursor may include impregnation, impregnation, wash coating, adsorption, ion exchange, precipitation, co-precipitation, deposition precipitation, sol-gel method, slurry dip-coating, microwave heating, and the like, or some other suitable method. Preferably the active catalyst material is deposited on or within the fibers or support structure by impregnation, wash coating or co-precipitation. Each metal salt coated piece is then dried, if necessary, and then calcined. Following calcination, the metal coated piece or pieces may be reduced, particularly if rhodium is a component.

An alternative method of making a thermomechanical stress-resistant catalyst for the production of synthesis gas is also provided by the present invention. In some embodiments the method comprises combining or mixing at least one refractory oxide, such as alumina, silica, boria, cordierite, magnesia or zirconia, with at least one salt of an active catalyst metal chosen from the group consisting of Rh, Ni and Cr. The method includes forming the combination into a plurality of ceramic oxide fibers, and then forming these fibers into one or more fibrous pieces. Such forming may include weaving or braiding together 2-dimensionally or 3-dimensionally at least some of the fibers. The pieces are then heated in a reducing atmosphere.

Another alternative method of making a thermomechanically stress resistant ceramic composite catalyst for the production of synthesis gas, in accordance with the present invention comprises forming a fibrous support having a predetermined 3-dimensional structure and comprising a plurality of metal oxide fibers having an organic coating and containing at least one metal oxide such as alumina, silica, boria, cordierite, magnesia or zirconia. The method includes infiltrating the support with an active catalyst precursor comprising at least one salt of a metal chosen from the group consisting of Rh, Ni and Cr, and combinations thereof. The catalyst-infiltrated fibrous support is then heated and or calcined, preferably at a temperature of 100-1000° C.

Still another alternative method of making a thermomechanically stress resistant ceramic composite catalyst for the production of synthesis gas, is provided in accordance with the present invention. Some embodiments of this method comprise forming at least one fibrous support having a predetermined 3-dimensional structure and comprising a plurality of metal oxide fibers having an organic coating and containing at least one of the metal oxides alumina, silica, boria, cordierite, magnesia and zirconia. The fibrous support may be formed by 2- or 3-dimensionally weaving or braiding together at least a portion of the metal oxide fibers. The method includes, optionally, heating and/or calcining the fibrous support or supports. Each support is then infiltrated with an active catalyst precursor comprising at least one salt of a metal chosen from the group consisting of Rh, Ni and Cr, and combinations thereof. The catalyst-infiltrated support is then heated or calcined.

A method of converting a C₁-C₅ hydrocarbon to synthesis gas is also provided in accordance with the present invention. Certain embodiments of this method comprise contacting a reactant gas mixture comprising said hydrocarbon and a source of oxygen with a catalytically effective amount of a thermomechanical stress resistant catalyst, in a short contact time syngas production reactor. The catalyst comprises a refractory fibrous structure containing a plurality of ceramic oxide fibers and at least one active catalyst material disposed on or within the fibrous structure. The active catalyst material is catalytically active for partially oxidizing methane to CO and H₂ at conversion promoting conditions, and the catalyst has sufficiently porous structure to allow reactant and product gases to flow through the catalyst at a space velocity of at least 20,000 normal liters of gas per kilogram of catalyst per hour (NL/kg/h) when the catalyst is used in a syngas production reactor. The method further includes maintaining the catalyst and reactant gas mixture at conversion promoting conditions of temperature and pressure during the contacting whereby a net partial oxidation reaction is catalyzed by the catalyst. In some embodiments the process provides at least about 65% CH₄ conversion, about 97-100% O₂ conversion, at least about 95% CO selectivity and at least about 78% H₂ selectivity, the molar ratio of H₂ and CO products being about 2.

In another embodiment of the method of converting a C₁-C₅ hydrocarbon to synthesis gas, the process comprises contacting a reactant gas mixture comprising the hydrocarbon and a source of oxygen with a catalytically effective amount of a ceramic composite catalyst. The ceramic composite catalyst comprises a refractory fibrous structure containing a plurality of fibers, said fibers containing a mixture of at least one active catalyst material and at least one ceramic oxide, and said active catalyst material having catalytic activity for partially oxidizing methane to CO and H₂ at conversion promoting conditions. The composite catalyst has sufficiently porous structure to allow reactant and product gases to flow through said composite catalyst at a space velocity of at least 20,000 normal liters of gas per kilogram of catalyst per hour (NL/kg/h) when a catalyst bed containing the composite catalyst is used in a syngas production reactor, as previously described.

In some embodiments of the method of converting a hydrocarbon to syngas, the method further includes combining at least one refractory oxide, such as alumina, silica, boria, cordierite, magnesia or zirconia, with at least one salt of an active catalyst metal such as Rh, Ni or Cr. The combination is then formed into a plurality of metal oxide fibers, which are then formed into at least one fibrous piece. These and other embodiments, features and advantages of the present invention will become apparent with reference to the following description.

### DETAILED DESCRIPTION OF PREFERRED EMBODIMENTS

New catalyst structures or articles, for catalytically converting C₁-C₅ hydrocarbons to CO and H₂ comprise active catalyst materials supported on ceramic oxide fibers comprised of refractory oxides such as alumina, silica, boria, cordierite, magnesia, zirconia and the like, and combinations thereof. The ceramic oxide fibers, which may have any of various fiber diameters, are arranged in a suitable 3-D form, such as a woven mesh design or layers, to provide a support structure. Preferably the support structure contains polycrystalline metal oxide fibers comprised of Al₂O₃, B₂O₃, SiO₂ or a combination thereof. Alternatively, commercially available refractory ceramic fibers or fabrics, such as those sold under the trademark Nextel by the 3M Company (St. Paul, Minn.), may be employed as suitable structures or structural elements providing high temperature stability. An active catalyst material is disposed on or within the support structure. Preferred active catalyst materials for catalyzing the net partial oxidation of light hydrocarbons to CO and H₂ include Ni, Rh, Cr, and combinations thereof.

The active catalyst material may be applied to the fibers or a 3-D support structure containing the fibers using well-known techniques such as impregnation, wash coating, adsorption, ion exchange, precipitation, co-precipitation, deposition precipitation, sol-gel method, slurry dip-coating, microwave heating, and the like, or some other suitable method. Preferably the active catalyst material is deposited on or within the fibers or support structure by impregnation, wash coating or co-precipitation, as demonstrated in the following examples.

Alternatively, the active catalyst components may be added to the powdered ceramic oxide compositions and then formed into fibers and woven to prepare the desired 3-D structure. The preferred polycrystalline fibers prepared in this manner are transparent, nonporous, and have a diameter of 10-12 microns. The continuous nature and flexibility of the ceramic oxide fibers allow them to be processed into a variety of textile shapes and forms using conventional weaving and braiding processes and equipment. This processability, coupled with the fibers' abrasion resistance, excellent tensile strength and refractoriness, permits the resultant textile shapes and forms to be useful as a catalyst support at temperatures greater than 1100° C.

The ceramic oxide fibers and textiles have outstanding thermal shock resistance due to the ability of the fibers to move relative to one another and relieve any thermomechanical stress, such as that which typically arises in a syngas production reactor. The supports maintain strength during and after exposure to high temperatures. The continuous nature of the ceramic oxide fibers makes them suitable for both 2-dimensional and 3-dimensional weaving or braiding of complex parts for composite supports. The preformed supports are infiltrated with the catalytic matrix by conventional impregnation techniques, chemical vapor infiltration (CVD/CVI) or matrix transfer molding. The organics and catalyst precursors are then heated and calcined away to produce the fiber-like ceramic composite catalyst. The ceramic oxide fibers have low elongation and shrinkage at operating temperatures, which allow for a dimensionally stable support. Heating and/or calcining are used to remove all of the organic compositions from the catalyst precursors when contained within the ceramic oxide fibers. This is important in applications where supports are pre-impregnated or coated with organic compounds and catalyst precursors. Preferably the heating and/or calcining treatment is conducted at temperatures ranging from 100 to 1000° C. Catalyst beds for reduced scale syngas production systems may be made up of layers of such ceramic fabric disks. Advantageously, the catalyst supports are easily formed and readily scaled to fit any reactor, and are resistant to thermal shock and consequential structural failure.

Catalyst Preparation

Representative catalyst articles were prepared, as described in Examples 1-4 below, and their activities were tested in a reduced scale syngas generation reactor, as described below under “Test Procedure” at defined high gas hourly space velocities, temperature and pressure to indicate the level of CH₄ conversion and selectivities to CO and H₂ products.

### EXAMPLE 1

### 5% Rh, 4% MgO/Nextel™ 440

A sample of Nextel™ 440 BF-20 was obtained from 3M Ceramic Textiles & Composites (St. Paul, Minn.) and heat treated at 900° C. for four hours to remove all of the organic coatings from the surface and to improve the chemical resistance. Nextel™ 440 BF-20 fabric is made of refractory aluminoborosilicate ceramic fibers and has the following properties:

Weight: 14.7 oz/yd² (508 g/m²)±10%

Max. Width: 36 in (0.91 m)

Thickness: 0.02 in (0.53 mm)±20%

Thread Count Per Inch: 30 in (12 cm) warp; 26 in (10 cm) fill (±2 end and 2 picks per inch)

Yarn Type: 2,000 denier roving warp; 2,000 denier roving fill

Air Permeability (at 0.5 in H₂O): 26 (ft³/min)/ft² ((7.9 m³/min)/m²)

Weave: 5 harness satin

Breaking load: 200 lbs/in (36 kg/cm) warp; 180 lbs/in (36 kg/cm) fill (w/o sizing)

MgO Coating: A MgO coating was applied to the heat treated sample as follows: In a 100 mL glass beaker 5.5710 g (3″×6″) of heat treated Nextel™ 440 was impregnated with a solution of Mg(NO₃)₂•6H₂O (1.8137 g) in 3 mL of deionized H₂O. After evaporating off the solvent at room temperature, the resulting material was further dried in a vacuum oven at 110° C. overnight and then calcined in air at 900° C. for three hours. The MgO coating was included in these examples to avoid possible negative support interaction of the Ni catalyst with the Nextel™ support. Although it is preferred to include the MgO coating, it is not catalytically active or a critical component for syngas production.

Rh Coating: A Rh coating was applied to the MgO coated support as follows: In a 200 mL glass beaker a piece of MgO coated Nextel™ 440 (2.1958 g) was impregnated with a solution of 0.2956 g of RhCl₃•3H₂O in 100 mL of acetone. After evaporating off the solvent at room temperature, the resulting material was further dried in a vacuum oven at 110° C. overnight, calcined at 600° C. for one hour and then reduced at 400° C. for four hours with 10 mL/min of H₂ and 90 mL/min of N₂.

### EXAMPLE 2

### 12%(Ni_{0.2}Cr_{0.8}), 4% MgO/Nextel™ 440

In a 100 mL glass beaker a piece of MgO coated Nextel™ 440 (1.0324 g) was impregnated with a solution of 0.1250 g of Ni(NO₃)₂•6H₂O and 0.3460 g of (CH₃CO₂)₇Cr₃(OH)₂ in 3 mL of H₂O. After evaporating off the solvent at room temperature, the resulting material was further dried in a vacuum oven at 110° C. overnight and then calcined in air at 1° C./min to 350° C., held for five hours at 350° C., raised the temperature to 525° C. at 10° C./min and held one hour at 525° C.

### EXAMPLE 3

### 5% Rh, 5% Ni, 4% MgO/Nextel™ 440

In a 100 mL glass beaker a piece of MgO coated Nextel 440 (2.4893 g) was impregnated with a solution of 0.7034 g of Ni(NO₃)₂•6H₂O and 0.4272 g of RhCl₃•3H₂O in 50 ml of acetone. After evaporating off the solvent at room temperature, the resulting material was further dried in a vacuum oven at 110° C. overnight, calcined at 600° C. for one hour and then reduced at 600° C. for four hours with 10 mL/min of H₂ and 90 mL/min of N₂.

### EXAMPLE 4

### 12% (Ni_{0.2}Cr_{0.8}), 5% MgO/Nextel™ 312

A sample of Nextel™ 312 AF-30 was obtained from 3M Ceramic Textiles & Composites. Nextel™ 312 AF-30 fabric is made of refractory aluminoborosilicate ceramic fibers and has the following properties:

Weight: 25.0 oz/yd² (586 g/m²)±10%

Max. Width: 36 in (0.91 m)

Thickness: 0.29 in (0.74 mm)±20%

Thread Count Per Inch: 19 in (7 cm) warp; 18 in (7 cm) fill (±2 end and 2 picks per inch)

Yarn Type: ½ warp; ½ fill (1800 denier yarn)

Air Permeability (at 0.5 in H₂O): 52 (ft³/min)/ft² ((15.8 m³/min)/m²)

Weave: Crow foot satin

Breaking load: 140 lbs/in (25 kg/cm) warp; 130 lbs/in (23 kg/cm) fill (w/o sizing)

Heat treatment and MgO coating were performed similar to that described in Example 1. The impregnation procedure went as follows: In a 100 mL glass beaker a piece of MgO coated Nextel™ 312 (3.4055 g) was impregnated with a solution of 0.4123 g of Ni(NO₃)₂•6H₂O and 1.1413 g of (CH₃CO₂)₇Cr₃(OH)₂ in 6 mL of H₂O. After evaporating off the solvent at room temperature, the resulting article was further dried in a vacuum oven at 110° C. overnight and then calcined in air at 1° C./min to 350° C., held for five hours at 350° C., after which the temperature was raised to 525° C. at 10° C./min and held one hour at 525° C.

Other properties of exemplary Nextel™ fibers are listed in Table 1.

TABLE 1
Nextel Ceramic Fiber Typical Properties*

| | Nextel | Nextel | Nextel | Nextel | Nextel |
|---|---|---|---|---|---|
| Property | 312 | 440 | 550 | 610 | 720 |
| Chemical | 62 Al₂O₃ | 70 Al₂O₃ | 73 Al₂O₃ | >99 Al₂O₃ | 85 Al₂O₃ |
| Composition | 24 SiO₂ | 28 SiO₂ | 27 SiO₂ | | 15 SiO₂ |
| (wt %) | 14 B₂O₃ | 2 B₂O₃ | | | |
| Filament | 10-12 | 10-12 | 10-12 | 10-12 | 10-12 |
| Diameter | | | | | |
| (μm) | | | | | |
| Crystal Size | <500 | <500 | <500 | <500 | <500 |
| (nm) | | | | | |
| Density | 2.70 | 3.05 | 3.03 | 3.88 | 3.40 |
| (g/cm³) | | | | | |
| Filament | 1700 | 2000 | 2000 | 2930 | 2100 |
| Tensile | | | | | |
| Strength (25, | | | | | |
| 4 mm gauge) | | | | | |
| (MPa) | | | | | |
| Filament | 150 | 190 | 193 | 373 | 260 |
| Tensile | | | | | |
| Modulus | | | | | |
| (GPa) | | | | | |
| Surface Area | <.2 | <.2 | <.2 | <.2 | <.2 |
| (m²/g) | | | | | |
| Thermal | 3(25- | 5.3 | 5.3 | 7.9 | 6.0 |
| Expansion | 500° C.) | | | | |
| (100- | | | | | |
| 1100° C.) | | | | | |
| (ppm/° C.) | | | | | |
| Dielectric | 5.2 | 5.7 | ˜5.8 | ˜9.0 | ˜5.8 |
| Constant | | | | | |
| (at 9.375 | | | | | |
| GHz) | | | | | |
| Refractive | 1.570 | 1.616 | 1.604 | 1.735 | 1.667 |
| Index | | | | | |
| *Data obtained from 3M ™ Nextel ™ Ceramic Fiber Technical Notebook, 98-0400-5870-7 1/99, | | | | | |
| # 3M Center, Bldg. 207-1W-11, St. Paul, MN 55144-1000. | | | | | |

Although the representative Examples describe impregnation of pre-formed ceramic fabrics, alternatively, the active catalyst components may be added to powdered ceramic oxide compositions, and then formed into continuous, flexible ceramic oxide fibers using conventional metal oxide fiber-forming techniques. The long, flexible, active catalyst-containing fibers may be processed into a variety of textile shapes and 3-dimensional forms using conventional weaving and braiding processes and equipment. In this way, transparent, nonporous polycrystalline fibers having a diameter of 10-12 microns are produced, using compositions similar to those described in any of Examples 1-4. The superior processability, coupled with the composite fibers' abrasion resistance, excellent tensile strength and refractoriness, permits the resultant textile shapes and forms to serve as a catalyst support or as an integral part of a catalyst structure functioning at temperatures greater than 1100° C.

In the tests, the ceramic oxide fiber or textile catalyst supports demonstrated outstanding thermal shock resistance due to the ability of the fibers to move relative to one another and relieve any thermomechanical stress. The supports maintain strength during and after exposure to high temperature. The continuous nature of the ceramic oxide fibers makes them suitable for both 2-D and 3-D weaving or braiding of complex parts for composite supports. The pre-formed supports are infiltrated with the catalytic matrix by conventional impregnation, chemical vapor infiltration (CVD/CVI) and matrix transfer molding techniques, and then the organics and catalyst precursors are heated and calcined away to produce a fiber-like ceramic composite catalyst. The ceramic oxide fibers have low elongation and shrinkage at operating temperatures, which allow for a dimensionally stable support. Heating and/or calcining are used to remove all of the organic compositions from the catalyst precursors when contained within the ceramic oxide fibers. This is especially useful for applications in which catalyst supports are coated with organics and catalysts precursors. Typically the heating and/or calcining are conducted at temperatures ranging from 100 to 1000° C. Alternatively, the catalyst composition is added subsequently to preparation of the ceramic metal oxide fiber support.

Catalyst beds for reduced scale syngas production systems are made up of layers or stacks of such ceramic fabric disks or pieces. The catalyst supports are easily formed and readily scaled to fit any reactor, and resist thermal shock. The active catalyst material may be disposed on or within the ceramic oxide fiber support structure.

### Test Procedure

Methane oxidation reactions were performed using a conventional flow apparatus with a 19 mm O.D.×13 mm I.D. and 12″ long quartz reactor. A ceramic foam of 99% Al₂O₃ (12 mm OD×5 mm of 45 ppi) were placed before and after the catalyst samples as radiation shields. Catalyst samples were in the form of a stack of ten 12 mm diameter fabric disks. The inlet radiation shield also aided in uniform distribution of the feed gases. An Inconel™ sheathed, single point K-type (Chromel/Alumel) thermocouple (TC) was placed axially inside the reactor touching the top (inlet) face of the radiation shield. A high temperature S-Type (Pt/Pt 10% Rh) bare-wire TC was positioned axially touching the bottom face of the catalyst and was used to indicate the reaction temperature. The catalyst and the two radiation shields were sealed tight against the walls of the quartz reactor by wrapping them radially with a high purity (99.5%) alumina paper. A 600 watt band heater set at 90% electrical output was placed around the quartz tube, providing heat to light off the reaction and to preheat the feed gases. The bottom of the band heater corresponded to the top of the upper radiation shield.

In addition to the TCs placed above and below the catalyst, the reactor also contained two axially positioned, triple-point TCs, one before and another after the catalyst. These triple-point thermocouples were used to determine the temperature profiles of reactants and products subjected to preheating and quenching, respectively.

All runs were done at a CH₄:O₂ molar ratio of 2:1 with a combined flow rate of 7.7 standard liters per minute (SLPM) (431,720 GHSV) and at a pressure of 5 psig (136 kPa), unless stated otherwise. The reactor effluent was analyzed using a gas chromatograph equipped with a thermal conductivity detector. The C, H and O mass balance were all between 98% and 102%. Test results for similar sized samples from Examples 1-4 are shown in Table 2.

TABLE 2
Nextel Supported Catalysts

| | | | CATAL. | | | | | |
|---|---|---|---|---|---|---|---|---|
| | CH₄:O₂ | PREHEAT | TEMP. | % CH₄ | % O₂ | % CO | % H₂ | H₂:CO |
| EX. | Ratio | (° C.) | (° C.) | Conv. | Conv. | Sel. | Sel. | Ratio |
| 1 | 2:1 | 511 | 803 | 84 | 100 | 97 | 94 | 1.94 |
| | 1.9:1 | 514 | 803 | 89 | 100 | 97 | 94 | 1.94 |
| 2 | 2:1 | 545 | 932 | 68 | 98 | 96 | 83 | 1.73 |
| 3 | 2:1 | 519 | 891 | 70 | 99 | 95 | 84 | 1.77 |
| 4 | 2:1 | 525 | 1046 | 66 | 97 | 96 | 78 | 1.63 |

Feed: 60% CH₄, 30% O₂, 10% N₂, catalyst bed: 10 layers, gases flow: 2.5 NLPM

Representative catalyst structures comprising Ni-Rh or Ni-Cr supported on MgO coated Nextel fabric disks demonstrated comparable CO product selectivity to that obtained with pure Rh on a MgO/Nextel support. In each case, a partial oxidation reaction apparently predominated in the conversion of methane to CO and H₂. The activity range of the exemplary catalyst structures is also comparable to that of conventional, more costly, Group VIII containing syngas catalysts. The new supported catalysts are more economically feasible for use in commercial-scale conditions than conventional partial oxidation syngas catalysts, and are particularly useful for generating syngas from naturally occurring reserves of methane which contain carbon dioxide. No coking of the catalysts of Examples 1-4 was visually apparent after on-stream testing. The test results obtained for the representative catalyst articles prepared according to the foregoing Examples are indicative of their activity in a commercial-scale synthesis gas production process.

### Process of Producing Syngas

A feed stream comprising a light hydrocarbon feedstock, such as methane, and an oxygen-containing gas is contacted with catalyst bed comprising an active syngas catalyst composition supported on a refractory ceramic textile, or an active fibrous ceramic composite catalyst (prepared substantially as described above). The catalyst bed is favorably arranged in a reaction zone maintained at conversion-promoting conditions effective to produce an effluent stream comprising carbon monoxide and hydrogen. Preferably a millisecond contact time reactor is employed, equipped for either axial or radial flow of reactant and product gases. The hydrocarbon feedstock may be any gaseous hydrocarbon having a low boiling point, such as methane, natural gas, associated gas, or other sources of light hydrocarbons having from 1 to 5 carbon atoms. The hydrocarbon feedstock may be a gas arising from naturally occurring reserves of methane which contain carbon dioxide. Preferably, the feed comprises at least 50% by volume methane, more preferably at least 75% by volume, and most preferably at least 80% by volume methane.

The hydrocarbon feedstock is in the gaseous phase when contacting the catalyst. The hydrocarbon feedstock is contacted with the catalyst as a mixture with an oxygen-containing gas, preferably pure oxygen. The oxygen-containing gas may also comprise steam and/or CO₂ in addition to oxygen. Alternatively, the hydrocarbon feedstock is contacted with the catalyst as a mixture with a gas comprising steam and/or CO₂. It is preferred that the methane-containing feed and the oxygen-containing gas are mixed in such amounts to give a carbon (i.e., carbon in methane) to oxygen ratio from about 1.25:1 to about 3.3:1, more preferably, from about 1.3:1 to about 2.2:1, and most preferably from about 1.5:1 to about 2.2:1, especially the stoichiometric ratio of 2:1.

The process is operated at atmospheric or superatmospheric pressures, the latter being preferred. The pressures may be from about 100 kPa to about 12,500 kPa, preferably from about 130 kPa to about 10,000 kPa. The process is preferably operated at temperatures of from about 600° C. to about 1200° C., preferably from about 700° C. to about 1100° C. The hydrocarbon feedstock and the oxygen-containing gas are preferably pre-heated before contact with the catalyst.

The hydrocarbon feedstock and the oxygen-containing gas are passed over the catalyst at any of a variety of space velocities. Space velocities for the process, stated as normal liters of gas per kilogram of catalyst per hour, are from about 20,000 to about 100,000,000 NL/kg/h, preferably from about 50,000 to about 50,000,000 NL/kg/h. The product gas mixture emerging from the reactor are harvested and may be sampled for analysis of products, including CH₄, O₂, CO, H₂ and CO₂.

While the preferred embodiments of the invention have been shown and described, modifications thereof can be made by one skilled in the art without departing from the spirit and teachings of the invention. The embodiments described herein are exemplary only, and are not intended to be limiting. For example, pure methane was employed in the representative test procedures, however, any light hydrocarbon (i.e., C₁-C₅) gaseous feedstock could also serve as a feedstock for the catalytic partial oxidation reaction catalyzed by the new thermal shock resistant ceramic fiber supported catalysts or ceramic composite catalysts. Many variations and modifications of the invention disclosed herein are possible and are within the scope of the invention. For example, the 2-3 and 3-D woven, braided and layered textile pieces or disk configurations described by the inventors are only a few of the many workable configurations the catalysts may assume, and which will provide the requisite porosity and thermomechanical stress resistance to the catalyst bed. Accordingly, the scope of protection is not limited by the description set out above, but is only limited by the claims which follow, that scope including all equivalents of the subject matter of the claims. The disclosure of U.S. Provisional Patent Application No. 60/177,432 filed Jan. 21, 2000 and the disclosures of all patents and publications cited herein are incorporated by reference.

What is claimed is:

1. A catalyst for catalytically converting a C₁-C₅ hydrocarbon to a product comprising CO and H₂, said catalyst comprising:
a refractory fibrous structure comprising a plurality of ceramic oxide fibers; and
at least one active catalyst material supported by said fibrous structure, said active catalyst material having catalytic activity for partially oxidizing methane to CO and H₂ at conversion promoting conditions.

2. The catalyst of claim 1 wherein said fibers are disposed in said structure such that they are able to move relative to one another within said structure, whereby thermomechanical stress is relieved when said structure is exposed to temperatures greater than 1000° C.

3. The catalyst of claim 1 further comprising a refractory oxide coating on said fibrous structure disposed between said fibrous structure and said active catalyst material.

4. The catalyst of claim 3 wherein said refractory oxide coating comprises MgO.

5. The catalyst of claim 1 wherein said ceramic oxide fibers comprise a refractory metal oxide chosen from the group consisting of alumina, silica, boria, cordierite, magnesia, zirconia, and combinations thereof.

6. The catalyst of claim 1 wherein at least some of said ceramic oxide fibers comprise a ceramic oxide chosen from the group consisting of Al₂O₃, B₂O₃, SiO₂, and combinations thereof.

7. The catalyst of claim 1 wherein said active catalyst material is chosen from the group consisting of Rh, Ni, Cr and combinations thereof.

8. The catalyst of claim 1 wherein said fibrous structure is a textile.

9. The catalyst of claim 1 wherein at least some of said fibers are woven together 2-dimensionally.

10. The catalyst of claim 1 wherein at least some of said fibers are woven together 3-dimensionally.

11. The catalyst of claim 1 wherein at least some of said fibers each have a diameter of 10-12 microns.

12. The catalyst of claim 1 wherein at least some of said fibers are polycrystalline metal oxide fibers.

13. The catalyst of claim 1 wherein said structure comprises a stack of at least two said fibrous pieces.

14. A ceramic composite catalyst for catalytically converting a C₁-C₅ hydrocarbon to a product comprising CO and H₂, said catalyst comprising a refractory fibrous structure containing a plurality of fibers, said fibers containing a mixture of at least one active catalyst material and at least one ceramic oxide, and said active catalyst material having catalytic activity for partially oxidizing methane to CO and H₂ at conversion promoting conditions.

15. A method of making a thermomechanical stress resistant catalyst for the production of synthesis gas comprising:
forming at least one fabric piece comprising a plurality of ceramic oxide fibers containing at least one refractory oxide chosen from the group consisting of alumina, silica, boria, cordierite, magnesia and zirconia;
optionally, coating said at least one fabric piece with MgO;
optionally drying and calcining each said MgO coated piece;
applying a metal coating on each said piece, said metal chosen from the group consisting of rhodium, nickel, chromium and combinations thereof; and
optionally, reducing said metal coating.

16. The method of claim 15 wherein said step of applying a metal coating on each said piece comprises applying a catalyst precursor coating to each said piece, optionally drying each said precursor coated piece, calcining each said precursor coated piece, and, optionally, reducing each said calcined piece.

17. A method of making a thermomechanical stress-resistant catalyst for the production of synthesis gas comprising:
combining at least one refractory oxide chosen from the group consisting of alumina, silica, boria, cordierite, magnesia and zirconia with at least one salt of an active catalyst metal chosen from the group consisting of Rh, Ni and Cr;
forming said combination into a plurality of ceramic oxide fibers;
forming said fibers into at least one fibrous piece;
heating each said piece in a reducing atmosphere.

18. The method of claim 17 wherein said step of forming said fibers into at least one fibrous piece comprises weaving together two-dimensionally at least some of said fibers.

19. The method of claim 17 wherein said step of forming said fibers into at least one fibrous piece comprises weaving together three-dimensionally at least some of said fibers.

20. The method of claim 17 wherein said step of forming said fibers into at least one fibrous piece comprises braiding together at least some of said fibers.

21. A method of making a thermomechanically stress resistant ceramic composite catalyst for the production of synthesis gas comprising:
forming a fibrous support having a predetermined 3-dimensional structure and comprising a plurality of metal oxide fibers having an organic coating and containing at least one metal oxide chosen from the group consisting of alumina, silica, boria, cordierite, magnesia and zirconia;
infiltrating said support with an active catalyst precursor comprising at least one salt of a metal chosen from the group consisting of Rh, Ni and Cr, and combinations thereof;
heating and/or calcining said catalyst-infiltrated support.

22. The method of claim 21 wherein said heating and/or calcining comprises heating at a temperature of 100-1000° C.

23. A method of making a thermomechanically stress resistant ceramic composite catalyst for the production of synthesis gas comprising:
forming at least one fibrous support having a predetermined 3-dimensional structure and comprising a plurality of metal oxide fibers having an organic coating and containing at least one metal oxide chosen from the group consisting of alumina, silica, boria, cordierite, magnesia and zirconia;
optionally, heating and/or calcining said at least one fibrous support;
infiltrating each said support with an active catalyst precursor comprising at least one salt of a metal chosen from the group consisting of Rh, Ni and Cr, and combinations thereof; and
heating and/or calcining each said catalyst-infiltrated support.

24. The method of claim 23 wherein said step of forming at least one fibrous support comprises two-dimensionally weaving or braiding together at least a portion of said metal oxide fibers.

25. The method of claim 23 wherein said step of forming at least one fibrous support comprises three-dimensionally weaving or braiding together at least a portion of said metal oxide fibers.

26. A method of converting a C₁-C₅ hydrocarbon to synthesis gas, the method comprising:
in a short contact time reactor, contacting a reactant gas mixture comprising said hydrocarbon and a source of oxygen with a catalytically effective amount of a refractory fibrous structure comprising a plurality of ceramic oxide fibers, and at least one active catalyst material supported by said fibrous structure, said active catalyst material having catalytic activity for partially oxidizing methane to CO and H₂ at conversion promoting conditions, said fibers disposed in said structure such that they are able to move relative to one another within said structure, whereby thermomechanical stress is relieved when said structure is exposed to temperatures greater than 1000° C., said refractory fibrous structure having sufficiently porous structure to allow reactant and product gases to flow through said composite catalyst at a space velocity of at least 20,000 normal liters of gas per kilogram of catalyst per hour (NL/kg/h) when said catalyst bed is used in a syngas production reactor;
maintaining said refractory fibrous structure and said reactant gas mixture at conversion promoting conditions of temperature and pressure during said contacting whereby a net partial oxidation reaction is catalyzed by said refractory fibrous structure.

27. A method of converting a C₁-C₅ hydrocarbon to synthesis gas, the method comprising:
in a short contact time reactor, contacting a reactant gas mixture comprising said hydrocarbon and a source of oxygen with a catalytically effective amount of a ceramic composite catalyst comprising:
a refractory fibrous structure containing a plurality of ceramic oxide fibers; and
at least one active catalyst material supported by said fibrous structure, said active catalyst material having catalytic activity for partially oxidizing methane to CO and H₂ at conversion promoting conditions,
said composite catalyst having sufficiently porous structure to allow reactant and product gases to flow through said composite catalyst at a space velocity of at least 20,000 normal liters of gas per kilogram of catalyst per hour (NL/kg/h) when said catalyst bed is used in a syngas production reactor;
maintaining said composite catalyst and said reactant gas mixture at conversion promoting conditions of temperature and pressure during said contacting whereby a net partial oxidation reaction is catalyzed by said composite catalyst.

28. The method of claim 27 further comprising:
combining at least one refractory oxide chosen from the group consisting of alumina, silica, boria, cordierite, magnesia and zirconia with at least one salt of an active catalyst metal chosen from the group consisting of Rh, Ni and Cr;
forming said combination into a plurality of metal oxide fibers;
forming said fibers into at least one fibrous piece;
heating each said piece in a reducing atmosphere, whereby said ceramic composite catalyst is produced.
